(19) United States
(12) Patent Application Publication
(10) Pub. No.: US 2009/0106671 A1
(43) Pub. Date: Apr. 23, 2009

(54) DIGITAL MULTIMEDIA SHARING IN VIRTUAL WORLDS

(76) Inventors: Donald E. Olson, Rochester, NY (US); John V. Nelson, Rochester, NY (US); Timothy L. Nichols, Spencerport, NY (US); Andrew C. Blose, Penfield, NY (US)

Correspondence Address: EASTMAN KODAK COMPANY;PATENT LEGAL STAFF, 343 STATE STREET, ROCHESTER, NY, 14650-2201, US

(21) Appl. No.: 11/876,013

(22) Filed: Oct. 22, 2007

(51) Int. Cl. G06F 3/048

(52) U.S. Cl. 715/757

(57) ABSTRACT

A method for producing and presenting a virtual immersive multimedia presentation in a virtual world environment. The method includes obtaining access to a plurality of digital multimedia, obtaining access to a virtual world environment capable of displaying digital multimedia. Based on a designated criteria automatically selecting one or more of the following: a subset of the digital multimedia from the plurality of digital multimedia, an immersive virtual environment from the plurality of prefabricated environments, and an avatar configuration from the plurality of avatar configurations for creating the digital multimedia presentation for display in the virtual world environment.

### FIELD OF THE INVENTION

The invention is related to a virtual environment for reliving memories by interacting with digital multimedia and more particularly to a method for the automatic creation of these virtual environments, multimedia presentations and sharing of these multimedia presentations.

### BACKGROUND OF THE INVENTION

Prior to 1850, the human need for memory keeping of friends and family was as fundamental as it is today. During that pre-industrial period, memory keeping was accomplished via artists who rendered silhouettes and painted portraits, which generally were, at best, approximate likenesses of the people they were meant to immortalize. Post-1850, silhouettes and portraits were quickly replaced by analog film photography, as photographs went well beyond likenesses to produce images representing what the subject actually looked like, were much cheaper to produce, and could be captured by the masses, not limited to a handful of itinerant artists. Clearly, history has shown that film photography was a better way of capturing memories for the masses than were silhouettes or painted portraits.

From the mid 1800's until well into the 20^{th} century, film photography improved in quality of image and flexibility for conditions under which an acceptable photograph could be acquired. Its usage became common for most households in developed countries around the world. But, a major shortfall of these film captured images was that one had to wait for chemical processing to see the outcome, and sharing images with distant relatives could take many days depending upon the speed of the mails. Digital image capture utilizing digital cameras was the next major leap forward providing instant capture and display of still images and video, the ability to store these images and videos in on-line Internet galleries and on digital memory devices, and to share these images via the Internet to family and friends all over the world in minutes, not days. Digital capture, digital storage, and Internet distribution provides numerous advantages over analog film photography.

Yet, significant shortfalls remain in the presentation of digital photography and digital video (hereafter referred to as digital multimedia).

The manner in which images are displayed when reliving memories often has minimal relationship to the environment in which the images were captured. This is true for both softcopy and hardcopy display. These displays are often very aesthetically pleasing and often use clever techniques to organize the images by event or theme. However, whether in albums, montages, collages, slideshows or other formats, the images are displayed in a manner that does not emulate the environment in which the memories were created. The viewing environment therefore is often non-synergistic, or even detracting, from the reliving of the memories. Further, whatever this viewing environment is, it is relatively fixed, with little ability to change it for the next viewing session's content, or based on the preferences of the user. Despite being able to share digital images all over the world via the Internet, typically families and friends living far apart are seldom physically together to collaborate in reliving these memories. Given this physical separation, one can not “see” or otherwise experience together the reaction of friends and family to digital multimedia, having to rely on spoken or written word via telephone or email, often hours or days after the excitement of the initial viewing. Written or spoken word alone is often inferior to “seeing” the physical reaction from friends and family in real time via facial expression, body language, as well as physical presence as a sign of each attendee's level of interest and commitment to the group.

Typical viewing conditions with one soft-copy display limit or curtail simultaneous multimedia (for example the simultaneous display of stills and video), or simultaneous viewing of content from multiple people. Further, on those occasions when many family and friends do gather to relive memories, the viewing environment often can not accommodate them, with restrictions to size of the room, seating arrangements, visual access to the screen, ambient lighting with glare, and other problems. Further, in a shared presentation each of the viewers is limited to viewing the same multimedia at the same time.

One (or even several) computer or television displays don't take advantage of the human ability to quickly glance or walk in a plurality of directions or to choose from multiple pathways, and branches off of those pathways.

Virtual Worlds exist in the electronic world. That is, virtual worlds can only be viewed through the utilization of electronic devices such as computers, and other display devices, such as PDA's, cell phones, etc. that communicate over a communication network, such as the Internet, with the virtual world. Virtual worlds are computer generated and are typically three-dimensional, immersive, and easily modified. A viewer enters the three-dimensional immersive environment through the use of an avatar, (a digital representation of a viewer). Avatars can “teleport” into a given environment in seconds from anywhere in the virtual world via their computer or other communication device. An avatar can walk, fly or otherwise move around within the virtual world. Virtual worlds almost eliminate distance as a barrier. This allows friends and family living far apart to visit and interact in a common virtual space as though they were in the same physical location. Avatars enable human-like communication via visual cues similar to those of real life, such as body language and facial expression, as well as text and voice.

Virtual world environments can be given the appearance and virtual area of large physical spaces thus readily accommodating gatherings of many people, represented as their avatars, more than adequate for typical family and friend group sizes. These virtual environments can be created to simultaneously show many images, still and video, so that large gatherings of avatars are not limited to viewing a single image or two. Entry into a given environment within a virtual world can be controlled by a variety of factors, for example on age, identity, group membership, or other desired factors.

Tools provided by the virtual world (such as camera tools in Second Life) give the avatar the ability to change views quickly, lock onto a specific subject, and to quickly zoom (the latter giving the impression that the avatar moved in very closely to the subject, without actually having to do so). These tools also give the avatar the ability to spin and look quickly in 360 degrees, then walk, run, fly, or teleport in whatever direction desired.

Creating a presentation for use in the virtual worlds to relive memories is a manual, labor-intensive process involving complex software tools that are beyond the technical capability of most users. As a result, virtual worlds are not widely used for the reliving of memories.

The concept of using captured images to create an immersive environment in a virtual world was recognized by Li, et al. in U.S. Pat. No. 6,633,317, Uyttendaele, et al. in U.S. Pat. No. 6,968,973, Aliaga, et al. in U.S. Pat. Nos. 7,027,049 and 7,126,603, Vincent in U.S. Pat. No. 7,050,102, and Foote, et al. in U.S. Pat. No. 7,096,428. However, the virtual worlds are created by dense video or still photography of the real world and are, therefore, limited to resembling a small and therefore insufficient area of the real world. In addition these methods involve specialized capture hardware or methodologies not used by a typical non-technical user.

U.S. Pat. No. 7,046,927 to Dalton discloses viewing of photographs in a virtual world. However, the images are manually selected from the limited collection on a digital camera and the virtual world is viewed only on the camera display (or on a television to which the digital camera is connected). These limitations force the user into the time-consuming task of manually selecting images, greatly restricting the range of virtual worlds that are created and preventing collaboration with users not in the immediate vicinity of the camera.

None of the prior art successfully utilizes the advantages of the virtual world to overcome the shortfalls described above. A presentation that is relatively simple for a non-technical individual to create and can fully take advantage of the attributes of virtual worlds thus enabling viewing experiences of family and friends, or colleagues from all over the world will have considerable value. The method would preferably also be capable of providing users with an arrangement to choose virtual world environment themes, and arrangements for the users to automatically acquire their real world digital multimedia and make it available in the virtual world for avatar viewing. The method should also make it possible for the users to limit access of who might be permitted to enter the virtual viewing environment.

### SUMMARY OF THE INVENTION

In accordance with one aspect of the present invention there is provided a method for producing a virtual immersive multimedia environment comprising the steps of:
a. obtaining access to a plurality of digital multimedia;
b. obtaining access to a virtual world environment capable of displaying digital multimedia;
c. based on designated criteria automatically selecting a subset of the digital multimedia from the plurality of digital multimedia; and
d. displaying the subset of the digital multimedia in the virtual world environment.

In accordance with another aspect of the present invention there is provided a method for producing a virtual immersive multimedia presentation comprising the steps of:
a. obtaining access to a plurality of digital multimedia, a plurality of prefabricated environments, and a plurality of avatar configurations;
b. selecting a theme for the virtual immersive multimedia presentation;
c. based on said selected theme automatically select a subset of the digital multimedia from the plurality of digital multimedia, an immersive virtual environment from the plurality of prefabricated environments, and an avatar configuration from the plurality of avatar configurations; and
d. automatically producing a virtual immersive multimedia presentation of said subset of digital multimedia in said selected prefabricated environment.

In accordance with yet another aspect of the present invention there is provided a method for producing a virtual immersive multimedia presentation comprising the steps of:

a. obtaining access to a plurality of digital multimedia and a plurality of prefabricated environments;

b. selecting a theme for the virtual immersive multimedia presentation;

c. based on said selected theme automatically selecting a subset of the digital multimedia from the plurality of digital multimedia and an immersive virtual environment from the plurality of prefabricated environments; and

d. automatically producing a virtual immersive multimedia presentation of said subset of digital multimedia in said selected prefabricated environment.

In accordance with still another aspect of the present invention there is provided a method for producing a virtual immersive multimedia presentation comprising the steps of:
a. manually selecting a theme for the virtual immersive multimedia presentation;
b. obtaining access to a plurality of digital multimedia, plurality of prefabricated environments, and plurality of avatar configurations;
c. based on said selected theme automatically selecting a subset of the digital multimedia from the plurality of digital multimedia, an immersive virtual environment from the plurality of prefabricated environments, and an avatar configuration from the plurality of avatar configurations;
d. automatically producing a virtual immersive multimedia presentation of said subset of digital multimedia in said selected prefabricated environment;
e. displaying said virtual immersive multimedia presentation in a virtual world;
f. permit avatar access to said virtual immersive multimedia presentation in said virtual world; and
g. automatically configuring avatars accessing the virtual immersive multimedia presentation using said avatar configuration.

In accordance with yet another aspect of the present invention there is provided a method for producing a virtual immersive multimedia presentation comprising the steps of:
a. manually selecting a theme for the virtual immersive multimedia presentation;
b. obtaining access to a plurality of digital multimedia and a plurality of prefabricated environments;
c. automatically selecting a subset of the digital multimedia from the plurality of digital multimedia and an immersive virtual environment from the plurality of prefabricated environments;
d. automatically producing a virtual immersive multimedia presentation of said subset of digital multimedia in said selected prefabricated environment;
e. displaying said virtual immersive multimedia presentation in a virtual world.

In accordance with yet still another aspect of the present invention there is provided a method for producing a virtual immersive multimedia presentation comprising the steps of:

obtaining access to a plurality of digital multimedia, a plurality of prefabricated environments, and a plurality of avatar configurations;

selecting a subset multimedia from said plurality of digital multimedia for the virtual immersive multimedia presentation;

based on said subset of multimedia automatically selecting a theme for said multimedia presentation;

based on said theme selecting an immersive virtual environment from the plurality of prefabricated environments; and

automatically producing a virtual immersive multimedia presentation of said subset of digital multimedia in said selected prefabricated environment.

The present invention is directed to overcome significant shortfalls in viewing and sharing digital multimedia, as described above, and takes full advantage of the capabilities of virtual worlds yet provides a relatively easy method for the creation of a digital multimedia presentation and sharing of the presentation among a plurality of viewers.

### BRIEF DESCRIPTION OF THE DRAWINGS

FIG. 1 is a system diagram for presenting a multimedia presentation made in accordance with the present invention;

FIG. 2 is a flowchart illustrating creating a multimedia presentation for use in a virtual world;

FIG. 3 is a screen shot illustrating the use of multiple virtual displays simultaneously in a virtual world;

FIG. 4 is a screen shot showing how virtual displays can appear relatively large when compared against a frame of reference such as an avatar; and

FIG. 5 is a flowchart illustrating the use of automatic layout algorithms utilizing GPS coordinates

### DETAILED DESCRIPTION OF THE INVENTION

The key components of this method are described in detail below with examples of preferred embodiments. It is understood that other embodiments may be utilized and modifications may be made without departing from the scope of the present invention.

For the purposes of the present invention a virtual world is a navigable, visual computer-simulated digital immersive virtual environment intended for its users to virtually inhabit and interact with other users via avatars (described below). These virtual worlds are typically accessed by users via a computer over a communication network such as the internet. The virtual world can be drawn, rendered by computers, or may be generated from photographic or video content, by combination of these methods, or other means. This virtual environment typically is represented in the form of a two-dimensional or three-dimensional space. The user controls their own avatar actions through the use of their computer or other appropriate electronic device. Because such avatars can affect the same environment simultaneously, a virtual world is said to be shared or multi-user. The virtual world continues to exist even when there are no avatars interacting with it, i.e., it is persistent. A virtual world can contain both public and private spaces. A public space is one in which there are no restrictions to which avatars can pass through or use the space. A private space is one in which one or more users can control access to the space by other avatars. A number of examples of virtual worlds are currently available, including Second Life, There, Club Penguin, and Whyville.

An avatar is a digital representation of a person or thing for use in a virtual world. An avatar of a person can have visual, vocal, gestures, mannerisms, or combinations thereof resembling the human it represents, or those of another human. An avatar can be embellished to provide “better” than real life appearance, features, and sound, or can take on the appearance, mannerisms, gestures, or sound of an entirely different individual or object. In fact, some avatars are shown as the personification of a cat, a car, or almost any manifestation that one can capture or imagine. Avatars can incorporate scripts. Scripts are computer programs that orchestrate the motion, action or response of an avatar or object in a virtual world to represent a recognizable movement, mannerism, or sequence. Examples of the scripted actions of avatars include walking, dancing, swimming, and gestures. All of these aspects of an avatar are part of its configuration. An avatar configuration can have options available to change its appearance, such as clothing color, hairstyle, or body measurement.

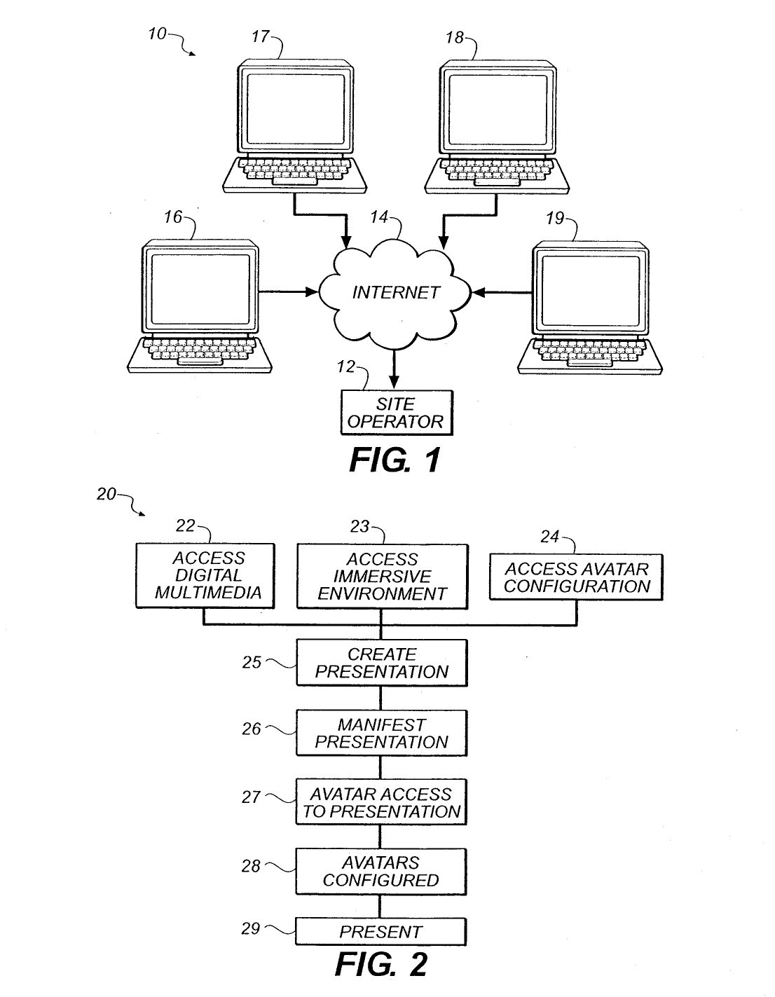

Referring to FIG. 1, there is illustrated a system 10 for practice of the present invention whereby users can access the virtual world. In particular, the system 10 includes a web site 12 having a virtual world that is accessible over a communication network 14. In the embodiment illustrated the communication network 14 is the Internet, however any suitable communication may used, for exampled telephone lines or a wireless telecommunication network. A plurality of devices 16, 17, 18, 19 are provided for allowing users to access and use the virtual world provided by the web site 12. FIG. 1 shows four devices 16, 17, 18, and 19. In fact, the number of devices can be many more than four, or less. These devices 16, 17, 18, and 19 may comprise any suitable device used for accessing and using the website 12. In the particular embodiment illustrated devices 16, 17, 18 and 19 are computers, however, they comprise any other suitable device, for example but not limited to a PDA, cell phone, I_POD, etc.

In accordance with one embodiment of the present invention for producing a virtual immersive multimedia presentation comprises three components, a set of digital multimedia, a prefabricated immersive environment, and an avatar configuration. The creation of a presentation for presentation in a virtual world may be provided by the virtual world web site 12 or on a user computer or other suitable electronic device. The presentation is created through the use of computer software present operating on a user computer or on a server at the virtual world web site 12 or other third party provider.

Referring to FIG. 2 there is shown a flow diagram 20 illustrating the steps for creating a multimedia presentation in accordance with present invention. The first steps in creating a present invention is to obtain access to the three components, that is, a digital multimedia 22, a prefabricated immersive environment 23, and an avatar configuration 24. The access to these components may be done in any order and by different means for each of the components.

The selection of multimedia can occur automatically or through user selection. For example if the user identifies a theme, the software program for creating the presentation can use meta data and/or image analysis techniques to locate images in user data bases or by accessing remote data bases over a communication network. Alternatively, the user may identify/select the images to be used and a theme for the presentation can be automatically selected/determined by the creation software by analyzing the meta data and/or image content. Digital multimedia include, but are not limited to, digital still images, videos, graphics, sound, or any other digital content either two or three dimensional. Digital multimedia can reside on-line, in a personal computer, on personal digital storage devices, or in another storage media or system. Personal digital storage devices are portable non-volatile storage devices such as memory cards, CDs, DVDs, and floppy disks. The digital multimedia is stored as individual files or in an organized structure such as an album. As previously discussed the digital multimedia may be owned/controlled by the user or may be hosted by a third party. Digital multimedia can originate in the real world, or the virtual world, or in any combination thereof, and be captured or created by the user, their extended network of family and friends, co-workers, colleagues, business partners, customers, third parties, or combinations thereof. A third party is an individual, company or vendor, not related to the user, capable of providing digital multimedia of interest to the user. The third party can provide the digital multimedia without cost or may charge a fee. Examples of third parties include professional photographers, stock photography agencies, other consumers, and resorts or other vacation destinations. The user through the software, as previously discussed, can obtain access to a plurality of digital multimedia by direct access to digital multimedia available to the user, searching for digital multimedia on the Internet, digital multimedia available from third parties, and other arrangements.

An immersive virtual environment is an on-line or otherwise digitally delivered computer generated three-dimensional representation of a setting (such as a building or a landscape) in which the user perceives their avatar to be within and interacting with, typically but not always within a much larger virtual world. The immersive virtual environment has navigable space within that can accommodate one or more avatars that can walk, run, fly, teleport, change their view, zoom, or any of a number of other movements within the space. There is no limit to the number or variety of immersive virtual environments designed, built, and deployed within a virtual world.

Stock three-dimensional environments are known as prefabricated environments (prefabs) meaning that the environment has been pre-designed and built for use by one or more potential users. The prefabs used in the invention are designed with pre-established locations for the incorporation of digital multimedia. These pre-established locations can take many forms and can accommodate all formats of digital multimedia. For example, a prefab can include picture frame openings on the walls of buildings or other structures, structural elements into which digital multimedia can be seamlessly merged, or areas on which the digital multimedia can be overlaid to produce an image combining elements of the prefab and the digital multimedia. The plurality of prefabs can be designed and built by the owner of the virtual world, other vendors, users of the virtual world, or any combination thereof. A prefab can be offered for use without fee or can require payment of a fee for its use. A prefab can include options for modification of its appearance such as colors of surfaces or the number and placement of decorative objects. Prefabs can be employed in private areas of the virtual world in which the user has the ability to restrict access by others, or used in public locations accessible to anyone. Access to a plurality of prefabs may be by direct use of those available to the user, searching prefabs available from virtual world providers and other third parties.

The avatars of users placed in a virtual immersive multimedia presentation allow the users of the avatars to view their own avatar and other avatars. As a result, the avatars of all involved users become part of the immersive presentation and their configuration can enhance or detract from it. In order to have a greater immersive experience, avatars are automatically configured as they enter the immersive environment of the multimedia presentation. For example, the automatic configuration of the avatar can align with the theme, with content that appears within the digital multimedia presentation, or with life stage or other variables that help describe the appearance of the individual represented by the avatar at the time that the digital multimedia was captured, at the time of viewing, or other desired basis. As a specific example, a group of avatars viewing a digital multimedia presentation at a high school reunion might want their avatars to appear (for example, facial features, hairstyle, clothing, sound, perfume) as they did when they were 18 years of age.

A plurality of avatar configurations is used as the third component for producing the virtual immersive multimedia presentation. The creation software used to create the presentation may obtain access to a plurality of avatar configurations by direct use of those available to the user, searching configurations available from virtual world providers and other third parties, and other arrangements.

A theme describes a particular set of digital multimedia. Themes are often characterized using a word, group of words, or phrase but can also be characterized using an image or other non-verbal descriptor. Examples of types of themes include people, places, things, events, projects, achievements, business offerings, and business needs. Specific examples of themes include the life of a child from birth to college graduation, a family vacation, a school reunion, a season for a sports team, and a property or item for sale.

The selection of a theme may be done manually by the user or is an automatic process of the creation software. An automatic process completes without any involvement from the user or with limited involvement. User input may be provided to affect the operation at key points during the presentation creation process. The automatic selection is accomplished using logical machine processing, metadata, other user information, or a combination thereof. In a fully automatic process, the creation software may complete all of the remaining steps in the invention without any intervention from the user. In an example of limited user involvement in the creation process, the creation software can offer the user a selection of themes and base further action on the user's response.

Software programs employed by the creation software processing may provide an automated process for the analysis of digital multimedia for the obtaining information used to determine themes related to the digital multimedia, select groupings of related digital multimedia, find related digital multimedia across multiple collections, and other tasks useful for the production of virtual immersive multimedia presentations. This automated process may be enabled by indexing strategies and semantic understanding algorithms as described below. It is understood by those skilled in the art that the creation software used to create the presentation can use sophisticated indexing strategies and that such strategies can be used to locate and identify digital multimedia for presentation. For example, the multimedia can be indexed in multiple categories such as based on multimedia content descriptions and inferences, in addition to keywords. Whereas keywords describe the circumstances surrounding the multimedia, that is, who, what, where, when, and why parameters, other content descriptors actually describe the data within the digital multimedia. Such factors are obtained from the digital multimedia itself and can include a color histogram, texture data, resolution, brightness, contrast, facial recognition, object recognition, metadata, text recognition, and other aspects of semantic understanding described in greater detail below. In addition, the content recording or utilization device itself produces another inferences element referred to as metadata (see below). By merging multimedia content data and descriptors and metadata from multimedia, event based perspective, or combinations thereof, establishing inference relations between multimedia and multimedia objects is accomplished. For example, using information associated with the multimedia, metadata such as GPS location information, time/date of recording/capture, and derived segment assignment such as eye/face recognition and object identification certain inferential relationships may be determined.

In addition to information gained directly from meta data and analysis of the image, semantic level understanding of the image/multimedia may be obtained using computer programs in producing a semantic web of information. This semantic level understanding can be applied to both individual images and to groups of images. Examples of methods for the analysis of individual images include main subject detection as disclosed in U.S. Pat. No. 6,282,317 by Luo et al., sky detection as disclosed in U.S. Pat. No. 6,504,951 by Luo and Etz, human figure detection as disclosed in U.S. Pat. No. 6,697,502 by Luo, object detection as disclosed in U.S. Pat. Nos. 7,035,461 and 7,263,220 by Luo and Crandall, and detecting subject matter regions as disclosed in U.S. Pat. No. 7,062,085 by Luo and Singhal. Images can be also analyzed to determine their degree of importance, interest or attractiveness; for example, as disclosed in U.S. Pat. No. 6,671,405 by Savakis and Etz and U.S. Pat. No. 6,847,733 by Savakis and Mehrotra. An example of the analysis of groups of images is disclosed in U.S. Pat. No. 7035,467 by Nicponski, analyzing images for cakes, brides, children and thus inferring the event, and global, national, regional, local and personal dates of significance such as holidays and birthdays. Additional examples of analysis of groups of images include grouping images based on similar appearance as disclosed in U.S. Pat. No. 6,826,316 by Luo et al, and U.S. Pat. No. 6,993,180 by Sun and Loui; and grouping images into events as disclosed in U.S. Pat. Nos. 6,351,556 and 6,606,411 by Loui and Pavie, U.S. Pat. Nos. 6,810,146 and 7,120,586 by Loui and Stent, and U.S. Pat. No. 6,915,011 by Loui et al. U.S. Pat. No. 6,389,181 by Shaffer et al. discloses the selection and grouping of images by a combination of automatic techniques. U.S. Pat. No. 5,652,880 by Seagraves discloses a framework for storing codified linkages between objects that can facilitate searching and retrieving semantic elements that are associated with content. Information obtained through this analysis can be used by the creation software for automatically selecting any of the components to be used in the presentation.

The content recording or utilization device, such as digital camera, can capture or collect data elements, known as metadata, that are associated with each individual digital multimedia file, including, but not limited to, the capture conditions, the time, the date, the GPS location of the capture device, the temperature of capture device, and the orientation of the capture device during the capture of that digital multimedia file, image orientation, image size (such as resolution, format, and compression), capture setting (such as sports, portraits, and macro), flash status (such as on, off, or fill), focus position, zoom setting, video sequence duration, video encoding type, and video key frame designation.

Other information useful in the creation software not provided by semantic understanding, from the digital multimedia, or from the metadata may be obtained from the user profile information such as birthdays, anniversaries, and lifestyle choices (for example, preferred vacation locations). These data also include preference information such as favorite image formats and types, virtual world used, and past purchase history for image products (virtual digital multimedia presentations and others).

In one embodiment of the present invention, the creation software to create the presentation (step 25, FIG. 2) may automatically select a theme based on analysis of the plurality of digital multimedia, plurality of prefabs, avatar configurations, and combinations thereof. For example, a beach vacation theme may be selected if analysis of the user's digital multimedia reveals that they recently visited the Caribbean. Or, a reunion theme may be selected if an analysis of the user information indicates that the date for a potential reunion recently passed, a reunion prefab is available, and an analysis of the digital multimedia of the user and their extended network of friends reveals that they all recently attended a reunion.

The selection of subset of digital multimedia, an immersive virtual environment, and avatar configuration for use in the virtual presentation may each comprise an automatic process provided by the creation software. An automatic process completes without any involvement from the user or with limited user input to affect the operation at key points during the multimedia creation process. The automatic selection of multimedia is accomplished using logical machine processing, metadata, other user information, or a combination thereof as described above. Based on the selected theme, a subset of digital multimedia, an immersive virtual environment, and avatar configuration are selected as three independent processes or as an interdependent process that interactively selects all three components.

The plurality of digital multimedia accessed during the selection process is often a very large collection, and is overwhelmingly large if the access extends across an extended network of family and friends, third parties, or a combination thereof. Further, these large collections can contain multimedia that traverses many subjects, occasions, or events. The selection of a subset of the digital multimedia, if appropriate, extracts a more manageable collection of the digital multimedia. When selection of the subset of digital multimedia is an independent process, the select multimedia can be related to the selected theme. For example, if the theme is a childhood history, face or people recognition techniques can be used by the creation software to find images of the child combined with date metadata, event detection, and other semantic techniques to select an appropriate subset of digital multimedia spanning the child's life from birth to high school graduation.

When the selection of the subset of digital multimedia is an interdependent process, then along with the theme, the selection of the immersive environment, the avatar configuration, or both will influence the selection. For example, again using the theme of a childhood history, the method can additionally use the criteria of which digital multimedia have a style and format that will best fit with the immersive environment being selected.

When there is limited involvement of the user in the automatic process, the user can influence the process prior to or after the subset is selected. Examples of limited user involvement in the automatic selection of the subset of digital multimedia include basing the selection on other criteria provided by the user (such as no multimedia charging a fee or no images that include my mother-in law) and permitting the user to add or delete digital multimedia from the subset.

The selection of an immersive environment from a plurality of prefabs establishes a setting for the virtual immersive multimedia presentation. When selection of the immersive environment is an independent process, an environment may be selected based the theme. For example, if the theme is a Caribbean vacation, analysis of the prefab content and other techniques are used to select an appropriate environment. When the selection of an immersive environment is an interdependent process, then along with the theme, the selection of the subset of digital multimedia, the avatar configuration, or both will influence the selection. For example, again using the theme of a Caribbean vacation, if the digital multimedia contains snorkeling or scuba scenes an underwater immersive environment may be selected. If the selected prefab includes options to modify its appearance, the creation software may automatically do so based on the theme, the subset of digital multimedia, the avatar configuration, or a combination thereof.

When there is limited involvement of the user in the multimedia presentation creation process, the user can influence the process prior to or after the presentation environment is selected. Examples of limited user involvement in the automatic selection of an immersive virtual environment include basing the selection on other criteria provided by the user (such as only using prefabs that have no fee), permitting the user to select a prefab from a list, and permitting the user to select the options for modifying the appearance of the prefab.

The selection of an avatar configuration from the plurality of accessed configurations establishes the appearance for avatar immersed in the virtual immersive digital presentation. The avatar configuration can include a single configuration, such as a scuba suit for an underwater environment, or multiple configurations where individual avatars will be configured based on parameters such as gender, body features, or user preference. When selection of the avatar configuration is an independent process, the method can select the configuration related to the theme. For example, if the theme is a high school reunion, the method can use the high school graduation date, style information about the available avatar configurations, and other techniques to select an appropriate configuration. When the selection of the avatar configuration is an interdependent process, then along with the theme, the selection of the subset of digital multimedia, the immersive environment, or both will influence the selection. For example, again using the theme of a high school reunion, if the subset of digital multimedia includes high school yearbook pictures, the avatars can be closely configured to match their high school appearance including facial features, hairstyles and clothing. If the selected avatar configuration includes options to modify its appearance, the method can automatically do so based on the theme, the subset of digital multimedia, the immersive environment, or a combination thereof.

When there is limited involvement of the user in the automatic process, the user can influence the process prior to or after the configuration is selected. Examples of limited user involvement in the automatic selection of the avatar configuration include basing the selection on other criteria provided by the user (such as only using avatar configurations of a particular style), permitting the user to select the avatar configuration from a list, and permitting the user to select the options for modifying the avatar configuration.

The selection process can cause the creation software to obtain access to additional digital multimedia, prefabs, avatar configurations, or combinations thereof to permit the production of one or more virtual digital multimedia presentations. For example, if analysis of the digital multimedia show that there are a number of underwater scenes available but no virtual immersive environment suitable for creating an underwater themed digital multimedia presentation is available from the current plurality of prefabs, then access to additional prefabs is employed by the software to obtain a suitable virtual immersive environment. This access to additional material may be an automatic process or one that involves limited user involvement.

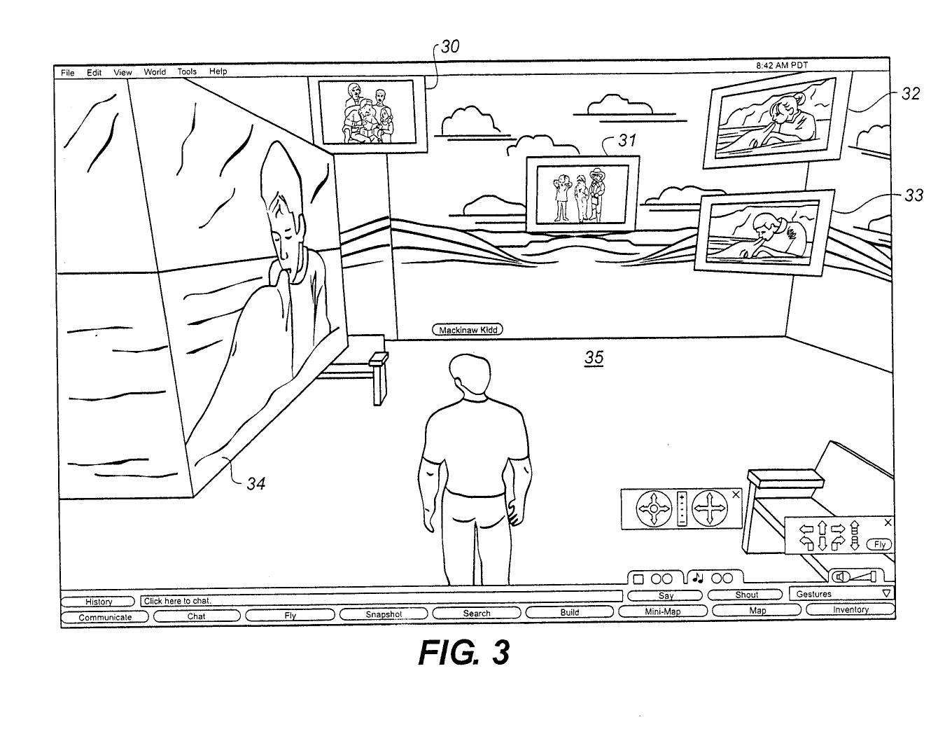

A virtual immersive multimedia presentation provides many more options than are typically available in the real world. Within the presentation space, there can be multiple locations, referred to in this application as “virtual displays”, where digital multimedia can be viewed by users via their avatars. As can be seen in FIG. 3, two or more digital multimedia presentations in a virtual environment can be simultaneously shown on separate virtual displays 30, 31, 32, 33 within a space 35, shown on a large virtual display 34, or combinations thereof. Virtual displays 30, 31, 32, 33 can show a static image, a sequence of static images (slide-show), video, or other forms of content. The virtual displays 30, 31, 32, 33, 34 can change their content or form of content in response to the presence or actions of one or more avatars.

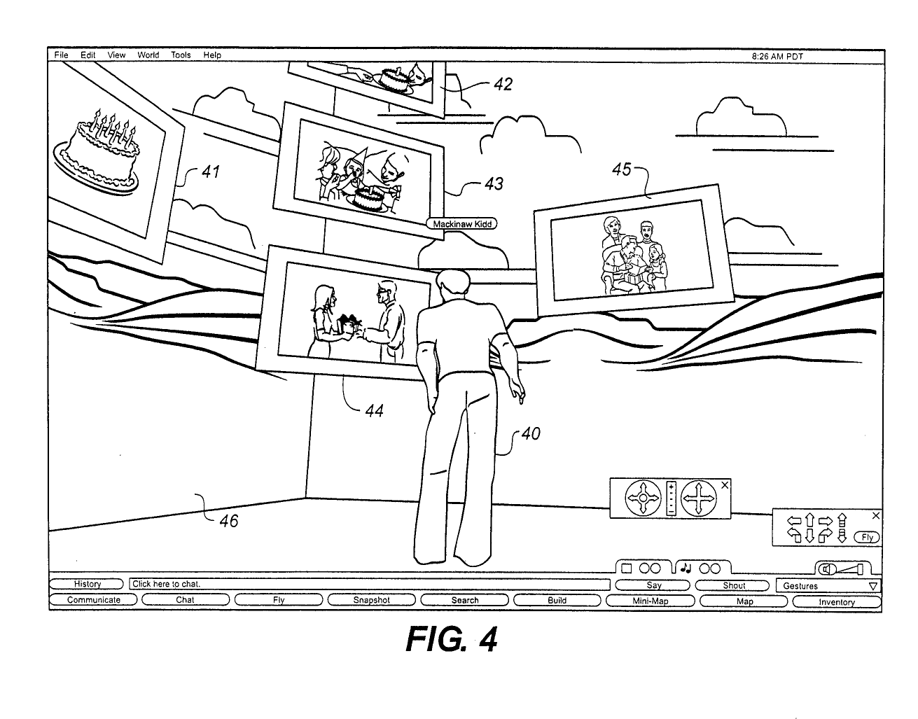

As can be seen in FIG. 4, the frame of reference provided by an avatar 40, gives a virtual display 41, 42, 43, 44, 45 that fills a seemingly large virtual space, such as a virtual wall 46, the impression of being much larger than its actual measured area, such that one can feel like one is looking at a display as big as a wall, or as big as a house, and so on. These virtual displays do not necessarily need to take the typical “rectangular” shape as in the real world, but rather can take the form of an object, stationary or moving. Further, the shape of these virtual displays can be fitted to the theme, and even integrated into the prefab, in which the digital multimedia presentation is being shown. For example, images can be displayed on an underwater billboard, or on the back of a giant squid within a theme of scuba diving. The presentation of the digital multimedia in the virtual immersive environment can take many forms ranging from a restricted single path past an ordered sequence of virtual displays and/or the viewer to a freely navigated space in the presentation so that the user(s) can approach the virtual displays in any order from multiple directions. The progress of the viewer's avatar through the presentation is under their own control, guided by another avatar, or controlled by the environment (such as a guided tour). The presentation in the virtual world provides an interactive action between multimedia being displayed and the viewer through its avatar and may be independent from the other viewers viewing the presentation

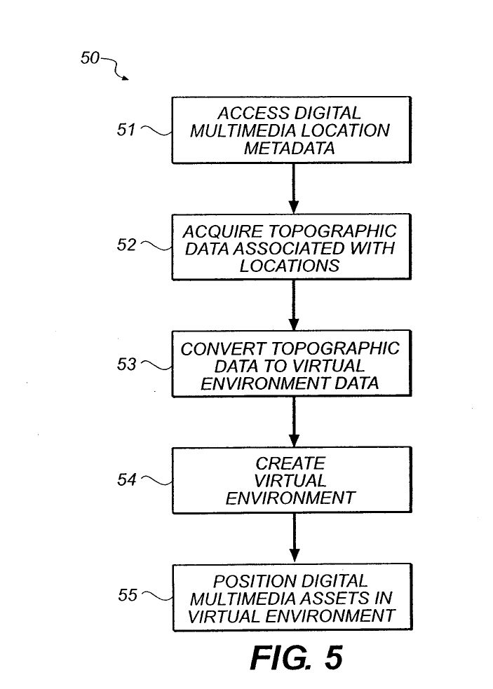

The creation software program according to the present invention produces a virtual immersive multimedia presentation that incorporates digital multimedia from a selected subset of digital multimedia into a selected virtual immersive environment. The incorporation of selected multimedia is based on the theme, indexing strategies, semantic understanding, metadata, other user information, or combinations thereof as described above. In addition, the incorporation of the multimedia in the presentation uses automatic layout algorithms. Automatic layout algorithms select locations for digital multimedia and combine the digital multimedia with the virtual immersive environment to produce a presentation. Examples of automatic layout algorithms are described in Watkins, et al. U.S. Pat. No. 5,459,189, Watkins, et al. U.S. Pat. No. 5,530,793, Gaglione and Morba U.S. Pat. No. 6,069,637, and Loui, et al. U.S. Pat. No. 6,636,648 which are hereby incorporated by reference herein. The GPS coordinates of the digital multimedia capture is often available in the metadata. The automatic layout algorithms can utilize the GPS coordinates to organize the images in an arrangement based on the real-world location of their capture. Referring to the embodiment of FIG. 5, a flow diagram 50 illustrates how an automatic layout algorithm is able to generate an arrangement based on real-world location data. In step 51, the location metadata is accessed in the captured digital multimedia, providing the real-world coordinates of the capture locations of each content asset. In step 52, topographic data is acquired for the locations accessed in step 51 from a database or from another source such as an online service. The topographic data acquired in step 52 is converted to spatially relative virtual environment data so that the 3D rendering of the virtual environment reflects the relative size and topography of the real world locations. The virtual environment is created in step 54 using the virtual environment data generated in step 52. In step 55, the location data accessed in step 51 is used to position the captured digital multimedia in the virtual environment. For example, the digital multimedia from a hike can be organized to along the hiking route or the digital multimedia from a visit to a theme park can be properly placed in a virtual world environment modeling the theme park.

When there is limited involvement of a user in the production of the virtual immersive multimedia presentation, the user can influence the process prior to or after the presentation is completed. Examples of limited user involvement in the creation of the virtual immersive multimedia presentation include permitting the user to designate some digital multimedia as higher priority for inclusion, permitting the user to change the size and placement of the individual digital multimedia, and permitting the user to modify the interactive pathways used by avatars to view the presentation.

The creation/production of the virtual immersive multimedia presentation may result in the modification of the selection of, and if necessary, obtain access to additional digital multimedia, prefabs, avatar configurations or combinations thereof to permit the production of one or more virtual digital multimedia presentations. For example, if there are not enough digital multimedia to fill all of the virtual displays in the virtual immersive environment or there is no selected digital multimedia that can fit the style or format of one of the virtual displays, then the software may select different multimedia (if necessary, obtaining access to this multimedia) or may select a different virtual immersive environment from the plurality of available prefabs.

The virtual immersive multimedia presentation produced by the creation software is then manifested in the virtual world (step 26, FIG. 2). The user can use the presentation immediately or wait for a more suitable time. In the virtual world, one can make arrangements to access and present the virtual immersive multimedia presentations, or have access to the presentation at any time within the virtual world should a spontaneous presentation opportunity occur or be requested.

A portable icon, which is an abbreviated representation of a given presentation, can be stored in a virtual world inventory. A virtual world inventory is a catalogue associated with the virtual world that contains references to the merchandise, clothing, tools, photos, and other items that an avatar has acquired, downloaded, or has access to during their time in and associated with the virtual world. Typically the inventory will be organized into a series of folders or tabs that facilitate finding a particular item. The user can pull the portable icon out of inventory as desired and then activated it to present the full two or three-dimensional presentation. After viewing, the user can deactivate the presentation to diminish it in size and area back to that of the portable icon, and store it once again in inventory for future use. These portable icons may be copied to the inventories of other avatars if permission is provided to perform that operation.

The user can display the virtual immersive multimedia presentation in a private or public area of the virtual world. In a private area, the user can restrict access to the presentation based on a list of individuals, or their avatars, chosen by the user. The user can invite others to view the presentation using E-mail, instant messaging, or any other communication method available within the real or virtual worlds. The avatars of the visitors can view the presentation individually or as an organized group. In a preferred embodiment of the present invention, as avatars enter the immersive environment of the presentation (step 27, FIG. 2), they are automatically configured (step 28, FIG. 2) using the avatar configuration selected by the method of the invention as previously discussed. While automatic avatar configuration can include limited user involvement, the user may have some limited involvement on how the entering avatars are to be configured. Examples of limited user involvement include letting the user decide which avatars are configured, letting the individual avatar owners decide whether or not to accept the configuration, or letting the user or avatar owner control an aspect of the configuration such as the color of the scuba suit in the scuba example above.

The digital multimedia presentation (step 29, FIG. 2) can be viewed using any device with an appropriate display that permits access to the virtual world: including, but not limited to, a personal computer, mobile phone, personal digital assistant, television, gaming system, or digital picture frame.

The following illustrates how a digital multimedia presentation can be delivered in a three-dimensional virtual world, including how the digital multimedia can be acquired for the presentation.

First a host user would choose the virtual world in which the presentation will be presented. Given the proliferation of virtual worlds with different capabilities and audiences, the user needs to choose a virtual world that provides certain capabilities, for example, but are not limited to:
a. at least temporary use of a portion of its real estate for one or more periods of time, either as public space or private space;
b. manifest a prefabricated virtual world environment on this real estate;
c. customize the sensory manifestations and accessories of this prefabricated environment, and save those customizations for reuse;
d. transfer or otherwise acquire digital multimedia into the virtual world;
e. permit display of digital multimedia;
f. invite selected users' avatars into this space;
g. control which avatars are given access to this space; and
h. configure the sensory manifestations and accessories of the invited avatars.

For a digital multimedia presentation intended to be private, acquire private space within the chosen virtual world. A portion of the virtual world needs to be set aside for presenting the digital multimedia presentation, and to accommodate only invited avatars. Typically, but not always, this would require buying, leasing, or renting an area of real estate within the virtual world large enough such that one can show the digital multimedia presentation, and provide sufficient space for the number of avatars expected to be invited.

When a digital multimedia presentation is intended to be public, the host can show the digital multimedia presentation anywhere within a virtual world where there are no restrictions as to what may be erected on that real estate, and to which avatars may enter the real estate, thereby eliminating the need to acquire private space.

In some virtual worlds that have creation software for creation of a presentation, as previously discussed, the presentation is created. Alternatively, if the presentation has been already created and is currently stored on the web site, host computer or some other location, the presentation is accessed and brought to the virtual world.

This may be accomplished by first naming each presentation, and then uploading the files of each presentation into the virtual world's inventory. Alternatively, the virtual world may access the presentation at a remote network location for presentation in the virtual world.

For a private digital multimedia presentation, the host, through the use of an appropriated device (computer, PDA, etc,) enters the virtual world, and navigates to the real estate previously acquired or otherwise defined. Alternatively, for a public digital multimedia presentation, the individual navigates to any appropriate public space within the virtual world.

The host next chooses which avatars will be invited to the presentation, and, for private presentations, grants access to the acquired real estate. These invitations and access rights may be done individually, or with predefined groups of avatars. Various arrangements are available to limit avatar access to the real estate for private presentations, including, but not limited to, selecting or otherwise adding the invited avatar's name, or group of avatars, to an access control list for the real estate.

For a private digital multimedia presentation, the host erects the prefab on the acquired real estate. This may be accomplished by activating the portable icon representing the prefabricated environment using a mouse right-click or other predefined activation procedure. Upon activation, the prefab environment appears around the individual such that the host is immersed within it and at the appropriate time the presentation will commence.

For a public digital multimedia presentation, the prefab may be erected anywhere within the virtual world without limited use or avatar restrictions, at any time.

The host may choose to customize the prefab automatically or semi-automatically, using logical machine processing, meta data associated, or combinations thereof with the digital multimedia.

For private digital multimedia presentations, avatars that have been given access to the real estate as acquired or otherwise defined, and as customized may now enter this real estate where the digital multimedia presentation will be shown.

Alternatively, for public digital multimedia presentations, avatars may enter the prefab at any time.

Avatars may be automatically, or semi-automatically, configured to fit the theme. This can occur automatically as the avatars enter the prefab, or chosen by the owner of the avatar later from within the prefab.

The display of the digital virtual multimedia presentation begins upon appropriate trigger, either selected by the host or by owner of the avatars that enter.

The owners of the avatars may choose how and where they view the digital multimedia presentation from within the prefab and which presentation to view if there are multiple presentations. They may choose an entirely automatic tour in which their avatar is guided along through the digital multimedia content as chosen entirely by the theme and logical machine processing or meta data consistent with that theme, or navigate randomly through the prefabricated environment, or any combination of those options. Thus, the owners of the avatars may choose their viewpoint within the presentation.

The digital virtual multimedia presentation ends at a designated time or at a time the host wishes to discontinue the presentation.

After all the avatars have finished, the host collapses the prefabricated environment back into its portable icon by deactivating it, then stores the portable icon back in inventory for possible use again at a later date.

The portable icon representing the prefabricated environment, and the digital multimedia presentation or presentations linked to it may be copied from the inventory or other repository within the virtual world to the inventory of other avatars within the virtual world for their potential future use. The following is one example that illustrates the use of a multimedia presentation made according to the present invention:

A family, consisting of a father, mother, daughter, and son vacation in the Caribbean, including two days at a scuba diving resort. During this vacation, each member of the family using their own capture device captures many digital photos and/or digital videos.

The family wishes to relive the vacation, and also to share the experience with friends and extended family. However, there are large barriers to reliving and sharing this vacation through traditional real world means using their digital multimedia content, as discussed above:
Family and friends live in several different cities, so there is little chance of getting them physically together, nor to experience the fun of seeing the reaction of others to particular content. It just isn't the same via email or over the phone. And even if they could get together, the family home isn't big enough to entertain the group, let alone do an adequate job of reflecting the compelling mood, colors, and sights they experienced at the scuba resort. Further, all of the family and friends would be crowded around one television or computer display, making it hard to for some to see, and providing for only one pathway through.

To overcome these limitations, the family decides to host a get together of family and friends to relive and share their vacation via a digital multimedia presentation in a virtual world. Following are steps that illustrate one embodiment of how the hosting of this digital multimedia presentation could be accomplished by this family, with the mother as the primary decision maker.

Step 1: Although there are many worlds to choose from, mom decides to host the event in Second Life, as that is the environment she is most familiar with.

Step 2: Mom emails a virtual world presentation vendor, who rents to her space within Second Life for the event. Mom chooses the size of the space needed, and the duration, to determine rental costs.

Step 3: Mom chooses a theme described as “scuba diving”.

Step 4: Based on the theme “scuba diving” the virtual world vendor provides mom with a prefabricated three-dimensional immersive environment that appears to be an underwater scuba-like environment. She stores this in her Second Life inventory. Other sensory multimedia, such as the sound of the ocean, is also included in the environment. The prefab environment exhibits water, fish, and geological formations.

Step 5: Although the family's database of digital multimedia takes up many gigabytes of memory, it is easy for mom to acquire the content she desires to include in the digital multimedia presentation. Mom, using the creation software, automatically searches the digital multimedia using the theme “scuba diving”, and further refines the search by adding the metadata “day/month/year” of the vacation.

Step 6: The resulting digital multimedia subset is stored in a folder on the hard drive of mom's personal computer.

Step 7: Mom reviews the digital multimedia subset on her computer, and deselects those images and videos for the purpose of the presentation that are not flattering to her.

Step 8: Mom semi-automatically organizes the digital multimedia subset into three different multimedia presentations. Three presentations are generated by the creation software from the digital multimedia, using a combination of logical machine processing and meta data to create three different presentations: A first presentation where the multimedia is presented in chronological order; a second presentation where her son is present; and a third presentation where the daughter is present. Each of the three multimedia presentations is based on the same vacation, but represents a different way of reliving the vacation.

Step 9: Transferring digital multimedia presentations into the virtual world. Mom uploads the three digital multimedia presentations into her Second Life inventory folder. Each presentation is given a different name:
a. chronological
b. son
c. daughter

Step 10: Mom teleports to the real estate rented by her from the virtual world presentation vendor

Step 11: Mom determines which friends and family will be given access to the multimedia presentation by selecting their Second Life avatar names and adding them to the access control list for the virtual world real estate she has rented. Those not selected cannot gain access that real estate, so unwanted avatars cannot indiscriminately wander in.

Step 12: Mom locates the portable icon in her Second Life inventory that embodies the prefabricated, three-dimensional immersive virtual environment, with scuba diving theme, that she has rented from the virtual world vendor, and activates it by right clicking. Activating the icon causes it to inflate to its full three-dimensional form, complete with multi-sensory content reflecting the chosen theme of scuba diving.

Step 13: Mom automatically customizes the prefab environment by replacing generic scuba diving images decorating the three-dimensional underwater prefab with family multimedia using logical machine processing to identify appropriate digital multimedia. But, she chooses to leave in place non-photorealistic graphics (such as a giant squid) that add great color and mood to the space.

Step 14: Avatars of family and friends log into Second Life and teleport to the real estate where the multimedia presentation will be shown. Once there, these avatars enter the prefabricated environment by walking down the incline from the beach to the underwater setting that was generated by activating the prefab in step 12.

Step 15: Avatars configured to fit theme. Once inside the prefab, invited avatars are automatically configured by the presentation software to appear as undersea divers, and are scripted to swim as a means of movement.

Step 16: Mom welcomes the 40 to 50 avatars who made their way to the vacation presentation. Avatars have arrived representing owners from three countries and 10 states in a matter of minutes. After welcoming the avatars and encouraging them to mingle, mom begins the digital multimedia presentations.

Step 17: Avatars choose many approaches to viewing the presentations. Some prefer to travel along a guided tour that automatically moves them along a path of digital multimedia as determined by the logical machine processing, others prefer to swim randomly from virtual display to virtual display as content interests them, and still others remain in one location and prefer to turn and zoom in on an individual virtual display. Avatars come and go as their owners please. Mom is delighted to be able to see the reactions to the presentations as expressed by the avatars.

Step 18: The time for the scheduled event flies by, and reluctantly, mom has to discontinue the presentations and ask avatars to leave, as her scheduled rental period for the prefab is over.

Step 19: Mom right clicks on the prefab control, and chooses the option to collapse it back to its portable icon. The portable icon is once again stored in her Second Life inventory.

Step 20: Mom gives copies of the digital multimedia presentations and portable icon representing the prefab to the avatars for their future use.

It is to be understood that various changes and modification may be made without departing from the scope of the present invention, the present invention being defined by the claims set forth herein.

1. A method for producing a virtual immersive multimedia environment comprising the steps of:
a. obtaining access to a plurality of digital multimedia;
b. obtaining access to a virtual world environment capable of displaying digital multimedia;
c. based on a designated criteria automatically selecting a subset of the digital multimedia from the plurality of digital multimedia; and
d. displaying the subset of the digital multimedia in the virtual world environment.

2. The method according to claim 1 wherein said plurality of digital multimedia is accessed from a user collection.

3. The method according to claim 1 said automatically selecting a subset of the digital multimedia comprises using meta data associated with said multimedia.

4. The method according to claim 1 said automatically selecting a subset of the digital multimedia comprises using information obtained from analyzing the digital image.

5. A method for producing a virtual immersive multimedia presentation comprising the steps of:
a. obtaining access to a plurality of digital multimedia and a plurality of prefabricated environments;
b. selecting a theme for the virtual immersive multimedia presentation;
c. based on said selected theme automatically selecting a subset of the digital multimedia from the plurality of digital multimedia and an immersive virtual environment from the plurality of prefabricated environments; and
d. automatically producing a virtual immersive multimedia presentation of said subset of digital multimedia in said selected prefabricated environment.

6. The method according to claim 5 further comprising the step of:
manifesting said presentation in a virtual world.

7. The method according to claim 6 further comprising the step of:
providing avatar access to said virtual world.

8. The method according to claim 5 further comprising the step of:
automatically configuring one or more avatars accessing the virtual immersive multimedia presentation using a selected avatar configuration.

9. The method according to claim 5 wherein said multimedia comprises one or more of the following:
digital images;
video;
sounds.

10. The method according to claim 5 said automatically selecting a subset of the digital multimedia comprises using meta data associated with said multimedia.

11. The method according to claim 5 said automatically selecting a subset of the digital multimedia comprises using information obtained from analyzing the digital image.

12. A method for producing a virtual immersive multimedia presentation comprising the steps of:
a. manually selecting a theme for the virtual immersive multimedia presentation;
b. obtaining access to a plurality of digital multimedia, plurality of prefabricated environments, and plurality of avatar configurations;
c. based on said selected theme automatically selecting a subset of the digital multimedia from the plurality of digital multimedia, an immersive virtual environment from the plurality of prefabricated environments, and an avatar configuration from the plurality of avatar configurations;
d. automatically producing a virtual immersive multimedia presentation of said subset of digital multimedia in said selected prefabricated environment;
e. displaying said virtual immersive multimedia presentation in a virtual world;
f. permitting avatar access to said virtual immersive multimedia presentation in said virtual world; and
g. automatically configuring avatars accessing the virtual immersive multimedia presentation using said avatar configuration.

13. The method according to claim 12 said automatically selecting a subset of the digital multimedia comprises using meta data associated with said multimedia.

14. The method according to claim 12 said automatically selecting a subset of the digital multimedia comprises using information obtained from analyzing the digital image.

15. A method for producing a virtual immersive multimedia presentation comprising the steps of:
a. manually selecting a theme for the virtual immersive multimedia presentation;
b. obtaining access to a plurality of digital multimedia and a plurality of prefabricated environments;
c. automatically selecting a subset of the digital multimedia from the plurality of digital multimedia and an immersive virtual environment from the plurality of prefabricated environments;
d. automatically producing a virtual immersive multimedia presentation of said subset of digital multimedia in said selected prefabricated environment;
e. displaying said virtual immersive multimedia presentation in a virtual world.

16. The method according to claim 15 further comprising the steps of:
providing avatar access to said virtual world; and
automatically configuring one or more avatars accessing the virtual immersive multimedia presentation using a selected avatar configuration.

17. The method according to claim 15 said automatically selecting a subset of the digital multimedia comprises using information obtained from analyzing the digital image.

18. A method for producing a virtual immersive multimedia presentation comprising the steps of:
obtaining access to a plurality of digital multimedia, a plurality of prefabricated environments, and a plurality of avatar configurations;
selecting a subset multimedia from said plurality of digital multimedia for the virtual immersive multimedia presentation;
based on said subset of multimedia automatically selecting a theme for said multimedia presentation;
based on said theme selecting an immersive virtual environment from the plurality of prefabricated environments; and
automatically producing a virtual immersive multimedia presentation of said subset of digital multimedia in said selected prefabricated environment.

19. The method according to claim 18 further comprising the step of:
obtaining access to a plurality of avatar configurations and selecting an avatar configuration from the plurality of avatar configurations based on said theme.

20. The method according to claim 18 further comprising the step of:
manifesting said presentation in a virtual world.

21. The method according to claim 18 further comprising the step of:
providing avatar access to said virtual world.

22. The method according to claim 18 further comprising the step of:
displaying said virtual immersive multimedia presentation.

23. The method according to claim 19 further comprising the step of:
providing access to said virtual by one or more avatars to said virtual world and automatically configuring said avatars accessing the virtual immersive multimedia presentation using said selected avatar configuration.

24. The method according to claim 18 wherein said selecting of said multimedia is done automatically using meta data associated with said multimedia.

25. The method according to claim 5 wherein said selecting of said multimedia is done automatically using information obtained from analyzing the digital image.
